(19) United States
(12) Patent Application Publication
(10) Pub. No.: US 2006/0185405 A1
(43) Pub. Date: Aug. 24, 2006

(54) Locks

(76) Inventor: Colin Sidney Middleton, Devon (GB)

Correspondence Address: BACHMAN & LAPOINTE, P.C., 900 CHAPEL STREET, SUITE 1201, NEW HAVEN, CT, 06510, US

(21) Appl. No.: 10/572,032

(22) PCT Filed: Sep. 24, 2004
(86) PCT No.: PCT/GB04/04094

§ 371 Date: Mar. 15, 2006

(30) Foreign Application Priority Data
Sep. 30, 2003 (GB) 0322874.9

(51) Int. Cl. E05B 65/06

(52) U.S. Cl. 70/134

(57) ABSTRACT

A lock for a door or the like which has a casing and a deadbolt assembly which comprises a bolt and a drive mechanism in the form of a cam of a cylinder lock which is adapted to be operated by a key. The drive mechanism is arranged to drive a coupler which is guided for sliding movement in the casing between a withdrawn position in which the bolt is located substantially wholly within the casing and an extended or thrown position in which a portion of the bolt projects from the casing. A lever in the form of a link is arranged between the coupler and the bolt, the link being pivotally mounted in the casing and provided with first engagement means in the form of a pin which is engageable in a slot in the coupler and second engagement means in the form of a slot which is arranged to engage with a pin on the bolt. The arrangement is such that, when the bolt is in the withdrawn position and the coupler is engaged by the cam to move the bolt to the thrown position, the link is engaged by the coupler and is effective to increase the movement of the bolt relative to the movement of the coupler thereby to increase the throw of the bolt.

This invention relates to improvements in locks and is particularly concerned with means for increasing the throw or movement of the deadbolt of a lock.

The maximum longitudinal movement or “throw” of the bolt of a mortice lock is limited by the width of the lock casing. Where a lock is to be installed in a solid wooden door, for example, the width of the casing is relatively unimportant because there is no restriction on the depth of the recess in the door which is to accommodate the lock casing. However, in the case of a predominantly glass door with a surrounding frame of wood or plastics material, the maximum width of the lock casing must be less than the width of the door style. Typically, the styles of such doors have a width in the region of 100 mm and the maximum overall width of lock casings which can be installed in such door styles is of the order of 75 mm.

In order to be fitted in such a door style, the maximum distance from the outside front of the casing to the axis of a cylinder for the lock, is of the order of 57.0 mm and the distance from the outside front of the lock forend to the said cylinder or lever key axis is commonly referred to as the backset. When such a lock is fitted with a deadbolt, the bolt is conventionally arranged to be driven by a cylinder cam or bolt thrower and, with a backset of only 57.0 mm, the maximum bolt projection, i.e. the distance by which the bolt projects from the front of the forend when the bolt is thrown, that can normally be obtained by direct drive from a cylinder cam or bolt thrower is of the order of only 14 mm This distance is insufficient to provide a secure locking engagement in the framework surrounding the door. A similar problem is encountered with deadbolts for multi-detainer mortice locks.

The problem becomes increasingly acute with the use of materials such as uPVC in which there is a substantial gap between the edge of the door and the surrounding frame. In order to meet the EU Standard, a throw of 20 mm is required so that the head of the deadbolt projects into a striking plate in the frame for a distance which is sufficient to make the door secure.

A lock has been proposed in WO95/01491 having a dead lock assembly which comprises a bolt and a drive mechanism adapted to be operated by a key, wherein the drive mechanism comprises a driving link arranged to be driven by a lever actuated by the key and arranged in turn to drive the bolt, and a quadrant for transferring the drive from the driving link to the bolt in such a manner that the movement or throw of the bolt is increased relative to the displacement of the driving link

While this prior arrangement can achieve the desired objective of increased bolt throw, the present invention aims to provide a mortice lock which is simpler to manufacture and yet still has an increased bolt projection or throw for a given width of lock casing in order to achieve a more secure engagement with the striking plate which is fitted to the door frame.

According to the present invention, there is provided a lock for a door or the like having a casing and a deadbolt assembly which comprises a bolt and a drive mechanism which is adapted to be operated by a key, wherein the drive mechanism is arranged to drive a coupler which is guided for sliding movement in the casing between a withdrawn position in which the bolt is located substantially entirely within the casing and an extended or thrown position in which a portion of the bolt projects from the casing and wherein a lever is arranged between the coupler and the bolt, the lever being pivotally mounted in the casing and provided with first engagement means arranged to co-operate with the coupler and second engagement means arranged to co-operate with the bolt, the arrangement being such that, when the bolt is in the withdrawn position and the coupler is engaged by the drive mechanism to move the bolt to the thrown position, the lever is engaged by the coupler and is effective to increase the movement of the bolt relative to the movement of the coupler thereby to increase the throw of the bolt.

Preferably, the lever is pivotally mounted about a follower for a handle for the lock.

The first engagement means desirably comprise a pin on the lever which is engageable in a slot in the coupler.

The second engagement means desirably comprise a slot in the lever which is adapted to receive a pin on the bolt.

The second engagement means should be located further from the pivot axis of the lever than the first engagement means.

According to a preferred embodiment of the invention, the drive mechanism comprises a rotatable cam.

The invention will now be described in detail, by way of example, with reference to the drawings in which:

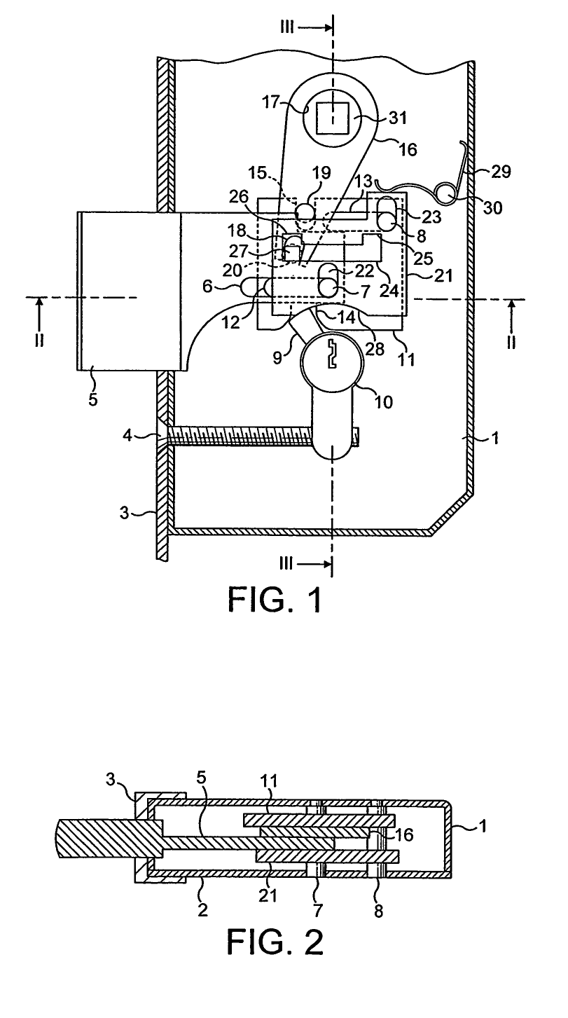

FIG. 1 is a side elevation of one embodiment of a lock according to the invention, only part of the casing being shown;

FIG. 2 is a section taken on the line II-II in FIG. 1 in the direction of the arrows;

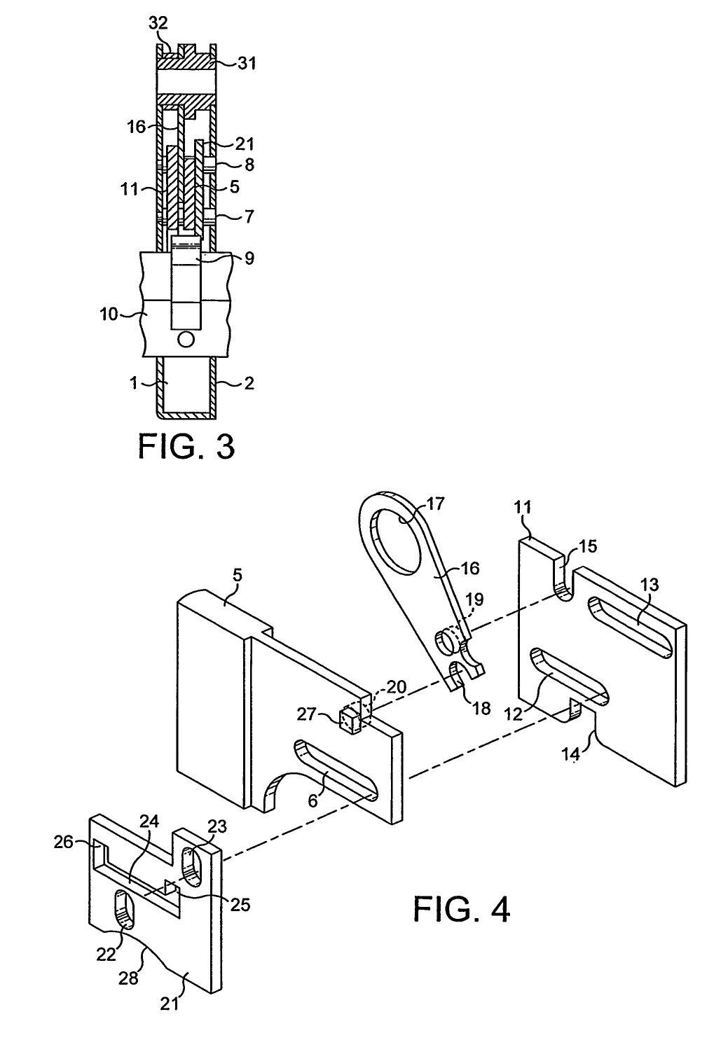

FIG. 3 is a section taken on the line III-III in FIG. 1 in the direction of the arrows;

FIG. 4 is an exploded perspective view of some of the components of a lock according to the invention;

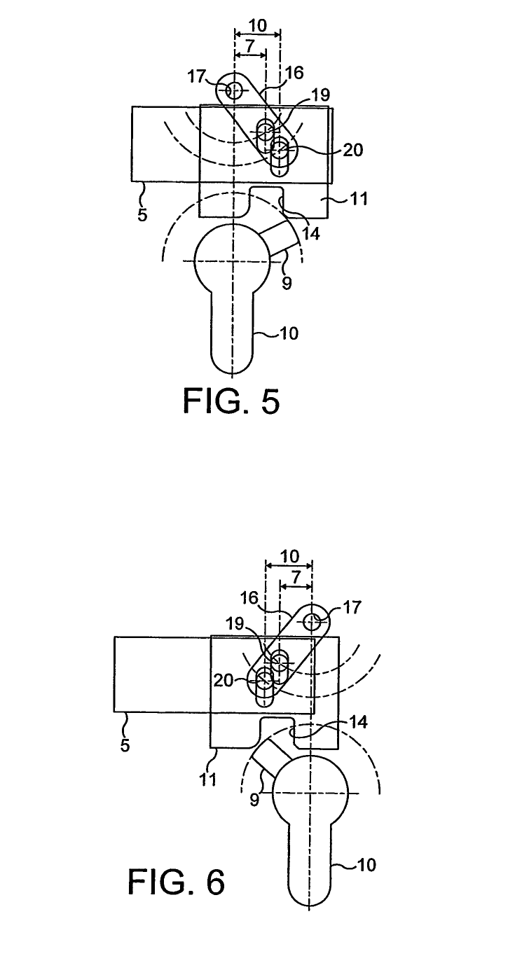

FIG. 5 is a diagrammatic view showing components of the lock with the deadbolt in the withdrawn position; and

FIG. 6 is a diagrammatic view showing components of the lock with the deadbolt in the thrown position.

In the drawings, like parts are denoted by like reference numerals.

Referring to the drawings, a lock according to the invention comprises a casing 1 to one side of which is mounted a foreend 3 which is secured to the casing by screws 4 (only one shown). The casing is arranged to be closed by a cover plate 2. The cover plate is omitted from FIG. 1 of the drawings in order to show the internal components.

A deadbolt 5 is slidably mounted in the casing and is arranged to extend through guides provided in apertures in a side wall of the casing 1 and in the foreend 3. The deadbolt 5 is provided with a slot 6 in which a column 7 projecting from the casing 1 is located. The slot 6 serves to guide the deadbolt in its movement in the casing 1 and limits the extent of movement of the deadbolt.

A coupler 11 is also slidably mounted in the casing between the casing wall and the deadbolt 5. The coupler is provided with two slots 12 and 13, the column 7 projecting through the slot 12 and a further column 8 projecting through the slot 13. The interengagement of the slots 12,13 and the columns 7,8 limits the extent of movement of the coupler and ensures that the coupler is capable of sliding movement only in the casing. The coupler 11 is provided with a further slot 14 in its lower edge which is arranged to receive the cam 9 of a cylinder lock 10 which extends through the casing 1.

A detainer 21 is arranged to overlie the deadbolt 5 and is provided with slots 22 and 23 in which the columns 7 and 8 are respectively located. A further substantially horizontal gate slot 24 is also provided in the detainer 21 said gate slot 24 terminating at each end in a respective gate aperture 25 and 26. A stump 27 is mounted on the deadbolt 5 and is receivable in the apertures 25 and 26 and can move along the gate slot 24. The lower edge 28 of the detainer is radiussed and is arranged to be engaged by the cam 9. A spring 29 mounted on a column 30 is arranged to bear on the detainer 21 to urge the detainer downwards (as viewed in FIG. 1 of the drawings) so that the stump 27 is held in one of the gate apertures 25 and 26 depending on the position of the deadbolt as will be hereinafter described.

Sandwiched between the deadbolt 5 and the coupler 11 is a lever in the form of a link 16 which provided at one end with a large circular aperture 17 by means of which the link can be pivotally mounted on a door handle follower 31 which extends through the casing 1 and which is adapted to receive the shaft of a door handle (not shown). The link 16 is spaced from the casing 1 by a spacer 32 mounted on the follower 31. The link 16 is provided, at its other end, with a slot 18 which is adapted to engage with a pin 20 projecting from a side of the deadbolt 5. The link 16 is further provided with a pin 19 which is engageable in a slot 15 provided in the upper edge of the coupler 11.

In the retracted or withdrawn position of the deadbolt 5, the stump 27 on the deadbolt 5 is held in the gate aperture 25 and is thus prevented from movement, the spring 29 ensuring that the detainer 21 is held in a position in which it is effective to retain the stump 27 in the gate aperture 25. When it is desired to move the deadbolt 5 to the thrown position, a key must be inserted into the cylinder lock 10 and turned in an anti-clockwise direction as viewed in FIG. 1 of the drawings. This has the effect of rotating the cam in an anti-clockwise and the cam engages the radiussed edge 28 of the detainer 21 to lift the detainer against the action of the spring 29 so that the gate aperture 25 is moved clear of the stump 27 and the stump is located in the gate slot 24 whereby the deadbolt is free to move.

Further rotation of the cam 9 causes it to enter the slot 14 in the coupler 11 and the coupler is then entrained by the cam and moved to the left as viewed in FIG. 1 of the drawings. This movement of the coupler to the left causes the link 16 to pivot in an anti-clockwise direction and by virtue of the engagement of the pin 20 by the slot 18, the deadbolt 5 is also moved to the left as shown in the drawings. This movement is continued until the stump 27 moves along the gate slot 24 until it reaches the other end of the slot when it is opposite the gate aperture 26. At this point, the cam 9 has reached the end of the radiussed edge 28 of the detainer 21 and further rotation of the cam moves it out of contact with the detainer. The spring 29 is now free to re-exert itself and move the detainer 21 downwards so that the stump 27 is engaged in the gate aperture 26 and the deadbolt 5 is held in the thrown position.

The lateral movement of the coupler 11 is 14 mm and the pivoting movement of the link 16 is approximately 32°. The spacing between the pin 19 on the link 16 and the slot 18 at the end of the link and the ratio of the distance from the pivot point of the link is 7:10. Thus, coupler movement of 14 mm will translate to deadbolt movement of 20 mm whereby the desired deadbolt throw of 20 mm can be achieved.

The deadbolt 5 can be moved from the thrown position to the retracted or withdrawn position by rotating the cam 9 in the opposite or clockwise direction as viewed in FIG. 1 of the drawings. As before, the cam 9 will initially engage the radiussed edge 28 of the detainer 21 to lift the detainer against the action of the spring 29. This has the effect of moving the gate aperture 26 out of engagement with the stump 27 and the stump is then again located in the gate slot 24. Further rotation of the cam causes it to re-enter the slot 14 in the coupler 11 and the coupler is then moved to the right as viewed in FIG. 1 of the drawings. This movement of the coupler causes the link 16 to rotate in a clockwise direction which has the effect of withdrawing the deadbolt 5 as a result of the engagement of the pin 20 by the slot 18 in link 16. When the deadbolt has been moved to the fully withdrawn position, the stump 27 is located at the other end of the gate slot opposite the gate aperture 25. The cam 9 has reached the end of the radiussed edge 28 of the detainer 21 and is now moved out of contact with the detainer. The spring 29 is again free to re-exert itself to move the detainer downwards so that the stump 27 is engaged in the gate aperture and the deadbolt 5 is held in the withdrawn position.

The invention is not restricted to the above-described embodiment but variations and modifications may be made without departing from the scope of the invention. For example, although the invention has been described and illustrated with reference to a lock operated by a dual profile pin tumbler unit the invention is also applicable to multi-lever locks.

1-5. (canceled)

6. A lock for a door or the like having a casing, a follower, a latch operated by the follower and a dead bolt assembly, wherein the dead bolt assembly comprises a bolt and a drive mechanism which is adapted to be operated by a key, wherein the drive mechanism is arranged to drive a coupler which is guided for sliding movement in the casing between a withdrawn position in which the bolt is located substantially entirely within the casing and an extended position in which a portion of the bolt projects from the casing an wherein a lever is arranged between the coupler and the bolt, the lever being pivotally mounted in the casing around the follower of the latch and provided with first engagement means arranged to co-operate with the coupler and second engagement means arranged to co-operate with the bolt, the arrangement being such that, when the bolt is in the withdrawn position and the coupler is engaged by the drive mechanism to move the bolt to the extended position, the lever is engaged by the coupler and is effective to increase the movement of the bolt relative to the movement of the coupler thereby to increase the throw of the bolt.

7. A lock according to claim 6, wherein the first engagement means comprises a pin on the lever which is engageable in a slot in the coupler.

8. A lock according to claim 7, wherein the second engagement means comprises a slot in the lever which is adapted to receive a pin on the bolt.

9. A lock according to claim 6, wherein the second engagement means comprises a slot in the lever which is adapted to receive a pin on the bolt.

10. A lock according to claim 6, wherein the lever has a pivot axis and wherein the second engagement means are located further from the pivot axis of the lever than the first engagement means.

11. A lock according to claim 7, wherein the lever has a pivot axis and wherein the second engagement means are located further from the pivot axis of the lever than the first engagement means.

12. A lock according to claim 8, wherein the lever has a pivot axis and wherein the second engagement means are located further from the pivot axis of the lever than the first engagement means.

13. A lock according to claim 9, wherein the lever has a pivot axis and wherein the second engagement means are located further from the pivot axis of the lever than the first engagement means.

14. A lock according to claim 6, wherein the drive mechanism comprises a rotatable cam.
